(19) United States
(12) Patent Application Publication
(10) Pub. No.: US 2016/0097358 A1
(43) Pub. Date: Apr. 7, 2016

(54) Fuel Injection Valve

(71) Applicant: HITACHI AUTOMOTIVE SYSTEMS, LTD., Ibaraki (JP)

(72) Inventors: Takao MIYAKE, Hitachinaka (JP); Akiyasu MIYAMOTO, Tokyo (JP); Motoyuki ABE, Tokyo (JP); Kiyotaka OGURA, Hitachinaka (JP); Takatoshi IIZUKA, Hitachinaka (JP)

(21) Appl. No.: 14/892,948

(22) PCT Filed: Mar. 12, 2014
(86) PCT No.: PCT/JP2014/056390

§ 371 Date: Nov. 20, 2015

(30) Foreign Application Priority Data
May 24, 2013 (JP) 2013-109472

(51) Int. Cl. F02M 51/06

(52) U.S. Cl. CPC F02M 51/061

(57) ABSTRACT

To improve the accuracy of an injection amount by a fuel injection valve, the open/close operation of a valve body needs to be performed promptly. This requires a configuration in which, immediately after starting movement of a movable member, fluid force generated at a seat portion of the valve body is not transmitted. It is also required to suppress a cohesion phenomenon between an end surface of an anchor and an end surface of a fixed core and to prevent sticking. To solve this problem, an electromagnetic fuel injection valve has a configuration in which a valve body includes a second valve body configured to abut against an anchor at valve close, a first valve body that abuts against the anchor at valve open. The second valve abuts against a stroke stopper arranged on an inner periphery of a fixed core at a time of valve-open.

### TECHNICAL FIELD

The present invention relates to a fuel injection valve used in an internal combustion engine, particularly to the fuel injection valve in which a fuel passage is opened and closed by an electromagnetically-driven movable member.

### BACKGROUND ART

An internal combustion engine is equipped with a fuel injection control device that performs computation for converting the amount of fuel that is suitable for an operation condition into the length of injection time for the fuel injection valve and then drives the fuel injection valve for supplying the fuel. The fuel injection valve performs fuel injection by causing a movable member included in the fuel injection valve to operate and open and close the valve body, by using a magnetic force generated by an electric current flowing in an internal solenoid. The amount of fuel injected is determined mainly by the difference between the fuel pressure and the atmospheric pressure at an injection port of the fuel injection valve and by the length of time for which the valve body is maintained in an open state and the fuel is injected.

In view of decreasing the amount of fuel consumption in recent years, occasions of fuel cut-off have been increasing. In this, fuel injection is not performed when an output of the internal combustion engine is unnecessary. Along with this, occasions of resuming fuel injection have been increasing. In resuming the fuel injection, it is required to inject a small amount of fuel that is substantially equivalent to no load. Meanwhile, to increase output and to improve exhaust performance, divided injection is performed. This aims to improve performance of the internal combustion engine by dividing the fuel needed for one injection into a plurality of times of injections and injecting the fuel at an appropriate timing. In the divided injection, it is required to decrease the amount of fuel injection for one injection.

In addition, downsizing of the internal combustion engine has been attempted to decrease the amount of fuel consumption when the engine is installed in a vehicle. In this case, supercharging of intake air requires improvement in specific power. It is thus required to increase the maximum injection amount without increasing the minimum injection amount, or after decreasing the minimum injection amount. This has led to an increasing dynamic range (value obtained by dividing the maximum injection amount by the minimum injection amount) desirable in the fuel injection valve.

A fuel injection valve includes, for example, an anchor having a cylindrical movable member, a plunger rod located at a central portion of the anchor, and a valve body provided at a tip of the plunger rod, and also has a magnetic gap between an end surface of a fixed core having a fuel introduction hole for introducing fuel into a central portion and an end surface of the anchor, and an electromagnetic coil for supplying a magnetic flux to a magnetic passage that includes the magnetic gap. The magnetic flux passing through the magnetic gap generates magnetic attraction between the end surface of the anchor and the end surface of the fixed core. The fuel injection valve is configured to drive the movable member by attracting the anchor toward the fixed core using the magnetic attraction and to separate the valve body from a valve seat to open a fuel passage provided at the valve seat.

In a conventional fuel injection valve configured in this manner, a force of pressing the valve body to the valve seat is constantly applied because of the difference between the fuel pressure upstream of the seat section and the atmospheric pressure downstream of the seat when the valve body is at a valve-close position. This causes a problem of a delay in valve-open operation by the movable member and the valve body even after the electromagnetic coil is energized. Fuel pressure in a fuel injection valve mounted on a gasoline internal combustion engine is increasing in recent years. Accordingly, the delay in valve-open is also estimated to increase.

This has been caused by a structure in which a force created by the difference in fuel pressure acting on the seat portion of the valve body and the atmospheric pressure is constantly transmitted via the plunger rod to the anchor.

A conventional art has disclosed a technique that has a configuration in which a gap is provided between the plunger rod and the anchor in a valve-close state to alleviate the above-described problem. This technique is intended to prevent a force generated by the difference between the fuel pressure applied to the seat portion of the valve body and the atmospheric pressure from transmitting at an initial stage at which the electromagnetic coil starts energizing, magnetic attraction is generated in a stator and the anchor, and the anchor starts moving.

As an exemplary conventional art, the movable member is preliminarily accelerated before reaching a first stopper provided on the valve needle, namely, before conveying the valve needle, and the movable member has reached an impulse transmitted by the movable member to the valve needed, before the valve conveys the valve needle. This method is known to achieve extremely short length of valve-open time and more precise quantity regulation of the fuel, compared with the fuel injection valve in which the movable member is rigidly connected to the valve needle or a fuel injection valve in which the movable member is movable with respect to the valve needle and contacts the stopper of the valve needle at an inoperative position (refer to PTL 1, for example). Furthermore in conventional fuel injection valves, a collision surface between the end surface of the anchor and the end surface of the fixed core stick to each other after the valve body fully reaches the valve-open position. This leads to a problem that, after energization to the electromagnetic coil is stopped for returning the valve body to the valve-close position and the magnetic force has disappeared from the magnetic passage, it takes a longer time for the anchor to return the anchor to an initial position, namely, the state in which the two sticky surfaces are completely separated and the valve body is press-fitted to the valve seat.

One of the reasons for this may be an occurrence of a fluid adhesion phenomenon between the end surface of the anchor and the end surface of the fixed core when the end surface of the anchor and the end surface of the fixed core start to separate from each other to gradually enlarge the magnetic attraction gap.

Specifically, the strength of the fluid force occurring in the movement of pasting the anchor to the fixed core has a property of being proportional to the moving speed of the anchor and inversely proportional to the cube of the size of the fluid gap. The fluid gap is yet too small to permit the fuel freely flowing into the gap from the outside immediately after the valve-open state has been switched to the valve-close starting state. Besides, inertia mass of the fluid surrounding the anchor causes the anchor to move at a very slow speed. The effect of the above phenomenon exhibits the behavior as if the end surface of the anchor might seem to be pasted on the end surface of the fixed core.

To alleviate the above phenomenon, it is important not to disturb, but consequently to urge a smoother flow of the fuel that occurs between the end surface of the anchor and the end surface of the fixed core and also around the anchor.

In an attempt to alleviate the above problem, a technique disclosed in a conventional art includes a method of using a partial area as the collision surface between the end surface of the anchor and the end surface of the fixed core so as suppress the cohesion phenomenon to prevent sticking.

As an exemplary conventional art, a fuel injection valve is known in which at least one of collision sections provided on a movable member has a width b that is a part of the region made by abutment of the end surface of the core and the end surface of the movable member. In this, the width b of the collision section is 20 to 500 μm, a step section located at a lower position than the collision section has a step bottom, and the step section is located at a lower position than the collision section by 5 to 15 μm (refer to PTL 1, for example). In the fuel injection valve, at least one of the mutually colliding components is configured such that, after the formation of the wear-resistant surface, the collision surface may not be undesirably expanded by wear after a long operation time. Therefore, the time in which the movable member moves by attraction of the fixed core and the time in which the movable member is released from the attraction of the fixed core and moves away from the fixed core are maintained substantially constant. Accordingly, optimization of magnetic and hydraulic properties is achieved.

As another exemplary conventional art, a fuel injection valve is known in which an anchor includes: a recess formed in a location facing an end portion of a fuel introduction hole of the fixed core in the central portion of the anchor; protruding areas formed at intervals circumferentially at the end surface of the anchor and in contact with the end surface of the fixed core; recess areas formed in the remaining portions at the end portions of the anchor; and a plurality of through holes, one end of which opens in those recess areas and another end of which opens around the plunger on the end surface opposite to the end surface of the fixed core (refer to PTL 2, for example). This fuel injection valve can achieve smooth flow of fuel around the anchor and also a quick supply of fuel to fill the gap between the end surface of the anchor and the end surface of the fixed core at a timing of the movable member transferring from the valve-open position to valve-close operation, enabling the anchor to be separated from the fixed core quickly and then reducing the valve-close delay time.

### CITATION LIST

### Patent Literatures

PTL 1: JP 2003-511602 A

PTL 2: JP 2007-187167 A

PTL 3: WO 2008/038395 A

### SUMMARY OF INVENTION

### Technical Problem

To implement an appropriate amount of fuel injection accurately from a fuel injection valve, quick open/close operation of the valve body with minimum variation is required. At the time of valve-open and valve-close of the fuel injection valve, however, a response delay due to actions of magnetic flux and fluid causes the open/close operation of the valve to finish with variation, later than the time desirable for the fuel injection control device as open/close time for the valve body.

One method for improving this response delay may be achieving a structure in which the fluid force generated in the seat portion of the valve body is not transmitted to the anchor at an early stage of generation of magnetic attraction.

Unfortunately, the configuration disclosed in PTL 1, has difficulty in simultaneously decreasing a squeeze force generated in a fluid gap between the core and the anchor, and reducing the response delay at valve-close.

### Solution to Problem

To solve the above-described problem, an electromagnetic fuel injection valve of the present invention has a configuration in which a valve body includes a second valve body configured to abut against an anchor at a time of valve-close, a first valve body that abuts against the anchor in a course of valve-open. In this configuration, the second valve abuts against a stroke stopper arranged on an inner periphery of a fixed core at a time of valve-open. In this configuration, the lengths of first valve and the second valve are prescribed such that a gap can be obtained without causing the fixed core and the anchor to abut directly against each other at the time of valve-open, and plating for the fixed core and the anchor is discontinued.

### Advantageous Effects of Invention

To increase the response speed of the valve body of the fuel injection value, provided is an internal configuration of the fuel injection valve that is inhibits the fluid force generated in the seat portion of the valve body from being transmitted to the anchor at an early stage of generation of magnetic attraction, and simultaneously suppresses, at the time of valve-close, occurrence of the cohesion phenomenon between the end surface of the anchor and the end surface of the fixed core, thereby preventing sticking. Accordingly, it is possible to achieve opening and closing operations of the valve body with higher response and smaller variation than conventional valves. This expands a control region of the amount of fuel injection and reduces the amount of injection in the internal combustion engine, leading to reduction in the amount of fuel consumption.

### BRIEF DESCRIPTION OF DRAWINGS

FIG. 1 is an overall sectional view of a fuel injection valve according to an embodiment of the present invention.

FIG. 2a is a detailed sectional view of the fuel injection valve according to an embodiment of the present invention.

FIG. 2b is a detailed view of the fuel injection valve according to an embodiment of the present invention.

FIG. 2c is a detailed sectional view of the fuel injection valve according to an embodiment of the present invention.

FIG. 3 is a diagram schematically illustrating an electric current, a force acting on a valve body, and time variation of value body displacement according to an embodiment of the present invention.

FIG. 4 is a detailed sectional view of the fuel injection valve according to a conventional embodiment.

FIG. 5 is a detailed partial sectional view of the fuel injection valve according to a conventional embodiment.

FIG. 6 is a detailed sectional view of the fuel injection valve according to an embodiment of the present invention.

FIG. 7 is a diagram schematically illustrating a squeeze force that acts on the fixed core and the anchor.

### DESCRIPTION OF EMBODIMENTS

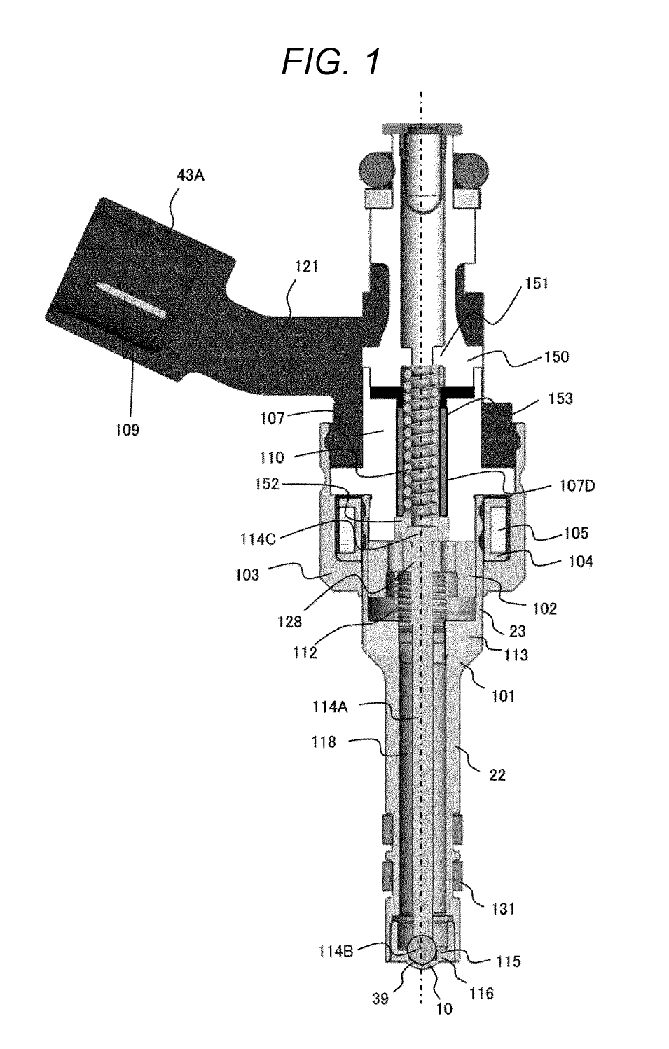

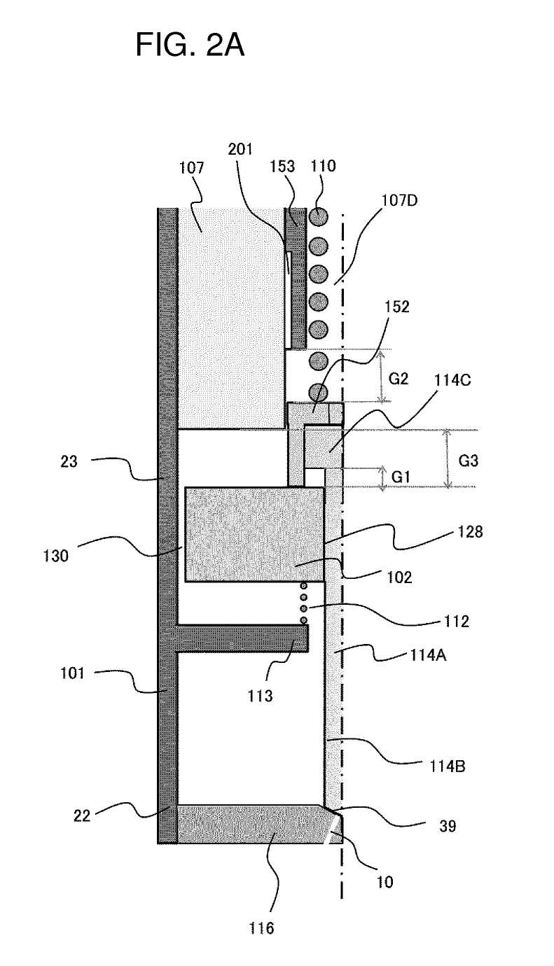

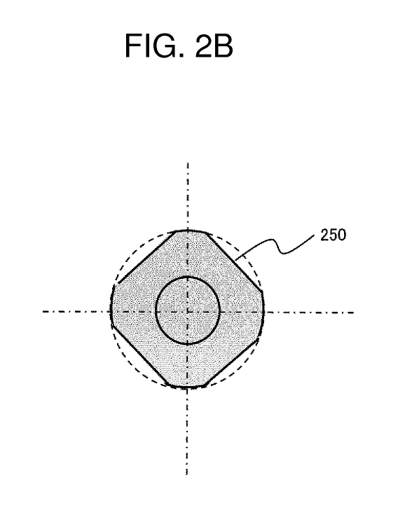

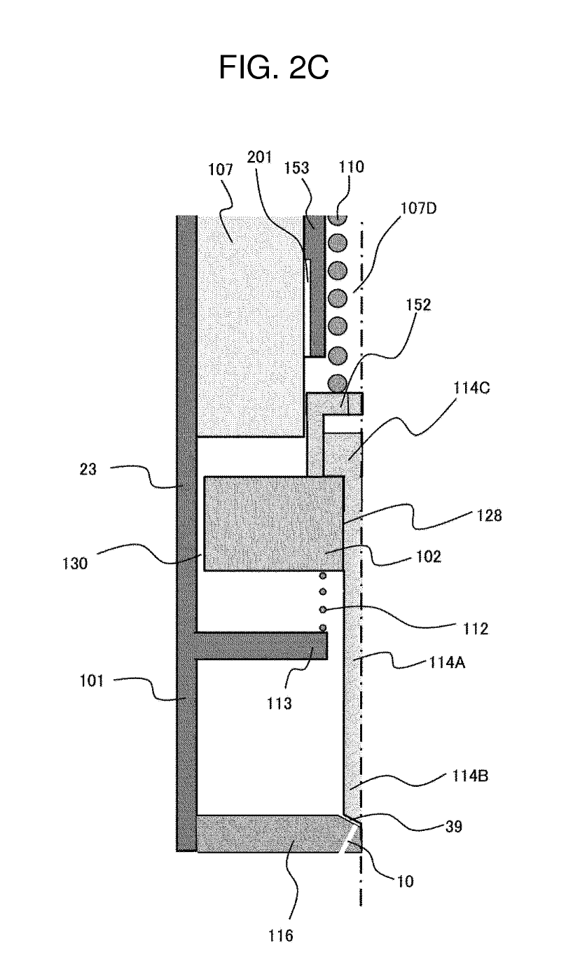

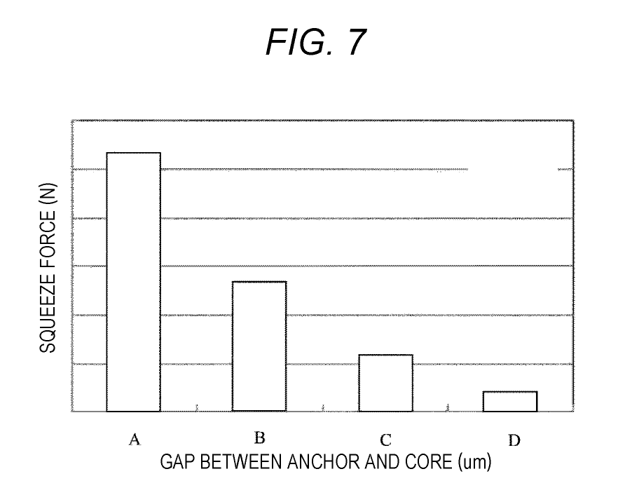

Hereinafter, an exemplary configuration of the fuel injection valve according to an embodiment of the present invention will be described with reference to FIGS. 1 to 7. FIG. 1 is a vertical sectional view of the fuel injection valve according to the present embodiment. FIGS. 2a to 2c, 4, and 6 are enlarged partial views of FIG. 1, illustrating details of the fuel injection valve according to the present embodiment. For convenience of description, the ratios of dimensions of components and gaps in the drawings are exaggerated and may be different from actual ratios. In the drawings, components other than the ones necessary for description of functions are omitted.

A nozzle holder 101 includes a small-diameter cylindrical portion 22 having a small diameter and a large-diameter cylindrical portion 23 having a large diameter. On an inner periphery portion of the large-diameter cylindrical portion 23 of the nozzle holder 101, a fixed core 107 is press-fitted, being weld-bonded at a press-contact position. This weld-bonding seals a gap formed between an inner portion of the large-diameter cylindrical portion 23 of the nozzle holder 101 and outside air. At an internal portion of a tip portion of the small-diameter cylindrical portion 22, an orifice cup 116 equipped with a guide portion 115 and a fuel injection port 10 is inserted and fixed by welding onto the small-diameter cylindrical portion 22 along with an outer periphery portion of the tip surface of the orifice cup 116. The guide portion 115 guides an outer periphery of a valve body 114B provided at a tip of a plunger rod 114A that is a component of a movable member 114 to be described below. On a side that faces the guide member 115 on the orifice cup 116, a conical valve seat 39 is formed. The valve body 114B provided at the tip of the plunger 114A abuts against the valve seat 39 for guiding and blocking a fuel flow to the fuel injection port 10. The nozzle holder 101 has a groove at its outer periphery. A seal member represented by a tip seal 131 made of resin is fitted into the groove.

The plunger rod 114A with an elongated shape has a head portion 114C having an outer diameter larger than a diameter of the plunger rod 114A on the end portion opposite to the end portion on which the valve body 114B is provided. At an upper portion of the head portion 114C, a second valve body 152 that is a member separate from the plunger rod 114A is arranged so as to cover an outer diameter portion of the head portion 114C. At an upper end surface, a seating surface of a spring 110 is provided. An outer periphery portion of the second valve body 152 is guided by an inner periphery portion of the fixed core 107, and also guides the head portion 114C of the plunger rod 114A at the inner periphery portion. Therefore, the plunger rod 114A is guided so as to be guided to perform a straight reciprocating motion in a longitudinal direction, by an inner periphery portion of the guide portion 115 of the orifice cup 116.

A spring reception surface formed on an upper end surface of the second valve body 152 abuts against a lower end of the spring 110 for initial load setting. Another end of the spring 110 is received by a recess 151 of the second core 150 to be press-fitted to the fixed core 107, whereby the spring 110 is held at a portion between the recess 151 and the second valve body 152.

The movable member 114 includes an anchor 102 having a through hole 128 at a center through which the plunger rod 114A penetrates. Between the anchor 102 and a shoulder portion 113 of the nozzle holder 101, a zero spring 112 is retained. The zero spring 112 biases the anchor in a valve-open direction. The biasing force acts on the anchor in the direction opposite to the biasing force generated by the spring 110.

FIGS. 2a to 2c are enlarged partial views of the fuel injection valve when the valve body 114B is in a valve-close state. The diameter of the through hole 128 is smaller than the diameter of the second valve body 152. Therefore, an upper side surface of the anchor 102 retained by the zero spring 112 and a lower end surface of the second valve body 131 abut against each other and are engaged with each other under a gravity or a biasing force of the spring 110 to press the second valve body 152 toward the valve seat 39 of the orifice cup 116. Accordingly, both move in cooperation with respect to an upward movement of the anchor 102 in defiance of the biasing force of the zero spring 112 or in defiance of gravity, or with respect to a downward movement of the second valve body 152 along with the biasing force of the spring 110 or gravity. However, when a force to move the second valve body 152 upward or a force to move the anchor 102 downward acts independently on the both regardless of the biasing force of the zero spring 112 or gravity, the both can move in separate directions.

The anchor 102 retains its central position not by the position between an inner periphery surface of the large-diameter cylindrical portion 23 of the nozzle holder 101 and an outer periphery surface of the anchor 102, but by an inner periphery surface of the through hole 128 on the anchor 102 and an outer periphery surface of the plunger rod 114A. That is, the outer periphery surface of the plunger rod 114A functions as a guide for the time when the anchor 102 moves independently in an axial direction. The lower end surface of the anchor 102 faces an upper end surface of the shoulder portion 113 of a rod guide. The surfaces, however, are not in contact with each other because of the zero spring 112 existing therebetween. Between the outer periphery surface of the anchor 102 and the inner periphery surface of the large-diameter cylindrical portion 23 of the nozzle holder 101, aside gap 130 is provided. The side gap 130 is provided for allowing the movement of the anchor 102 in an axial direction and the movement of the fuel inside the fuel injection valve. The size of the side gap 130 is determined in association with magnetic resistance.

At a center of the fixed core 107, a through hole 107D having a diameter D slightly larger than the diameter of the second valve body 152 is provided as an fuel introduction path. An inner periphery of a lower end portion of the through hole 107D, the second valve body 152 is inserted in a sliding state. FIG. 2b is a schematic diagram of the second valve body 152 viewed in the direction of the fixed core 107. On an outer diameter of the second valve body 152, a plurality of members 250 partly chamfered on a round shape are provided to be a passage for allowing the fuel from the through hole 107D to flow downstream. The second valve body 152 is formed with a non-magnetic material to prevent magnetic flux leakage from the fixed core 107 to the second valve body 152.

On an outer periphery of the large-diameter cylindrical portion 23 of the nozzle holder 101 illustrated in FIG. 1, a cup-shaped housing 103 is fixed. At a center of a bottom of the housing 103, a through hole is provided. On this through hole, the large-diameter cylindrical portion 23 of the nozzle holder 101 is inserted. An outer periphery wall portion of the housing 103 forms a outer periphery yoke portion facing an outer periphery surface of the large-diameter cylindrical portion 23 of the nozzle holder 101. Inside a cylindrical space formed by the housing 103, an annular or cylindrical electromagnetic coil 105 is disposed. The electromagnetic coil 105 includes an annular coil bobbin 104 and a copper wire. The annular coil bobbin is formed so as to open outwardly in a diameter direction, a cross-section thereof having a U-shaped groove in which the copper wire is wound. To each of winding start/end portions of the coil 105, a conductor 109 is fixed, which is pulled out of the through hole provided on the fixed core 107. On the outer periphery of each of the conductor 109, the fixed core 107, and the large-diameter cylindrical portion 23 of the nozzle holder 101 is molded by insulating resin injected from an inner periphery of an upper end opening of the housing 103 so as to be covered with resin molded body 121.

To a connector 43A provided at a tip portion of the conductor 109, a plug is connected to supply power from high-voltage power source and buttery power source to control energized/non-energized states by a controller (not illustrated). When the coil 105 is energized, a magnetic flux passing through a magnetic circuit formed with the core 107, the housing 103, and the anchor 102 generates a magnetic attraction on a magnetic attraction gap G3 in FIG. 2a between the anchor 102 of the movable member 114, and the fixed core 107. The anchor 102 is attracted by a force that exceeds the load setting for the spring 110 and moves upwardly. An upward movement of the plunger rod 114A by the anchor 102 causes the valve body 114B at a tip of the plunger 114A to be separated from the valve seat 39. Subsequently, the fuel is caused to pass through a fuel passage 118 and then is injected into a combustion chamber of the internal combustion engine, from the injection port 10 at a tip of the orifice cup 116.

When the power supply to the electromagnetic coil 105 is interrupted, the magnetic flux of the magnetic circuit disappears, and the magnetic attraction in the magnetic attraction gap G3 disappears as well. In this state, a spring force of the spring 110 for initial load setting that presses the second valve body 152 in a direction opposite to the magnetic attraction overcomes the force of the zero spring 112, acting on the entire movable member 114 (anchor 102 and plunger rod 114A). As a result, the spring force of the spring 110 pushes the anchor 102 back to the close position in which the valve body 114B contacts the valve seat 39. At this time, the second valve body abuts against an upper surface of the anchor 102, and moves the anchor 102 toward the shoulder portion 113 of the rod guide, overcoming the force of the zero spring 112. When the valve body 114B collides with the valve seat, since the anchor 102 is a separate body from the plunger rod 114A, the anchor 102 continues movement by an inertia force in a direction toward the shoulder portion 113 of the rod guide. At this time, the fluid generates friction between an outer periphery of the plunger rod 114A and the inner periphery of the anchor 102, attenuating kinetic energy of the anchor 102. The anchor 102 has large inertial mass and is separated from the plunger rod 114A. Accordingly, the plunger rod 114A has a small rebound energy for rebounding from the valve seat 39 in a direction toward the valve-open position. The anchor 102 absorbs the rebound energy of the plunger rod 114A by friction generated by the fluid and decreases its own inertia force correspondingly. This also decreases repulsion to be received after compressing the zero spring 112. Therefore, it is possible to suppress a phenomenon that the plunger rod 114A is moved again in a direction toward the valve-open position due to a rebound phenomenon of the anchor 102. This thus minimizes the rebound of the plunger rod 114A and inhibits, after interruption of the power supply to the electromagnetic coil (104 and 105), occurrence of valve opening and an unintended injection of the fuel, namely, a secondary injection phenomenon.

Hereinafter, features of the present embodiment will be described. In an enlarged partial view in FIG. 2a, a gap G1 is provided between a lower end surface of the head portion 114C of the plunger rod 114A and an upper end surface of the anchor 102. Between a lower end surface of a stroke stopper 153 press-fitted to an inner diameter portion of the fixed core 107 and the upper end surface of the second valve body 152, a gap G2 is provided. A lower end surface of the fixed core 107 and the upper end surface of the anchor 102, a gap G3 is provided. With the above component configuration and the gaps for the movable member 114 at the time of valve-close on the valve body 114B, it is possible to implement specific operation of the fuel injection valve according to the present embodiment. Details of the operation and effects will be described below.

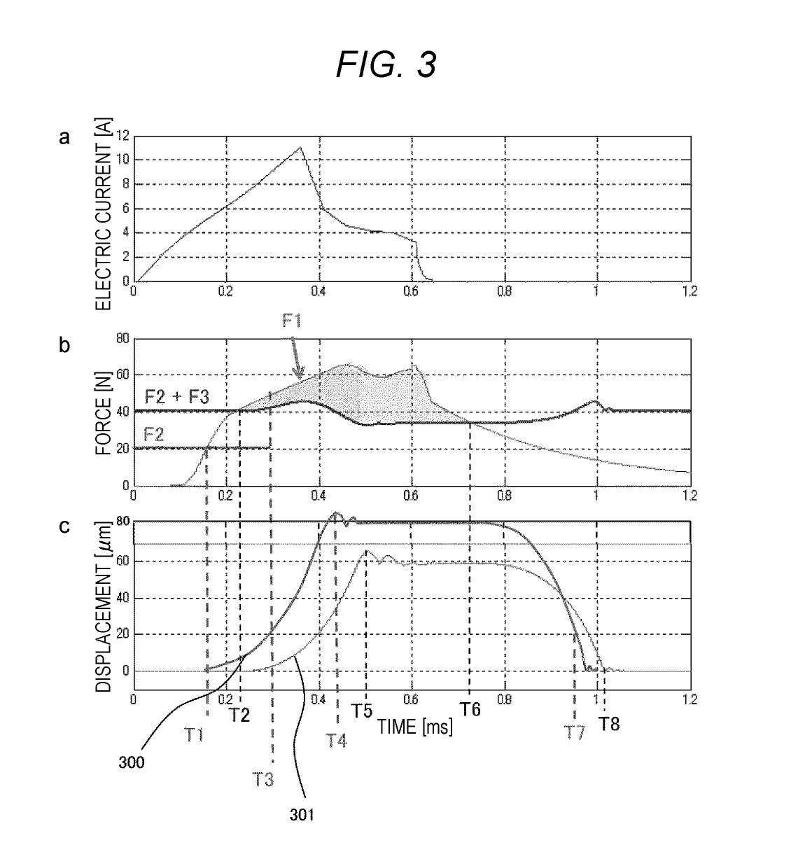

FIGS. 3a to 3c schematically illustrate the electric current applied to the electromagnetic coil 105, the force acting on the valve body 114B, and the operation, with the horizontal axis representing the time, when the valve body of the fuel injection valve is operated from valve-open to valve-close. To drive the fuel injection valve, the electric current illustrated in FIG. 3a is applied to the electromagnetic coil 105 of the fuel injection valve. A force attracted in the direction toward the fixed core (magnetic attraction) acts on the anchor 102 as illustrated as F1 in FIG. 3b. On the other hand, a biasing force F2 of the spring 110 acts on the anchor 102, via the second valve body 152, in a direction to pull the anchor 102 away from the fixed core. Accordingly, to cause the anchor 102 to start moving in the direction of the fixed core, it is required that the attraction F1 of the electromagnetic coil exceeds the biasing force F2 of the spring 110.

When the magnetic attraction F1 exceeds the spring biasing force F2 at time T1 in FIG. 3c, the anchor 102 starts moving in the direction of the fixed core 107 as illustrated as a line 300 in FIG. 3c. The anchor 102, however, does not move in cooperation with the plunger rod 114A until the gap G1 between the anchor 102 and the head portion 114C of the plunger rod 114A becomes zero. Herein, the state in which the magnetic attraction F1 moves the anchor 102 alone in the direction toward the fixed core is referred to as a preliminary stroke. For convenience of description, the gap G1, namely, the amount of preliminary stroke is assumed to be 20 um, for example.

FIG. 2c illustrates the state that, at time T3, the anchor 102 moves by 20 um and is engaged with the lower end surface of the head portion 114C of the plunger rod 114A. When the upper end surface of the anchor 102 comes in contact with the lower end surface of the head portion 114C of the plunger rod 114A, the anchor 102 and the plunger rod 114A move in cooperation. Then, the valve body 114B separates from the valve seat 39 of the orifice cup 116, and injection starts from the injection port 10 into the combustion chamber of the internal combustion engine. The state in which the valve body 114B is separated from the valve seat 39 is referred to as a regular stroke.

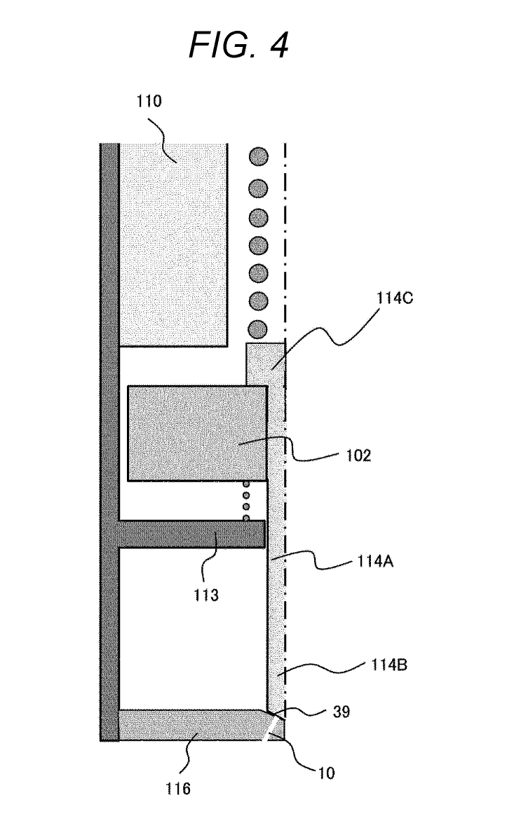

FIG. 4 is an enlarged partial view of a fuel injection valve for comparison when the valve body 114B of the conventional fuel injection valve is in a valve-close state. The upper end surface of the anchor 102 and the lower end surface of the head portion 114C of the plunger rod 114A are engaged with each other without any gap.

At the time of valve-close on the valve body 114B, the valve seat 39 of the orifice cup 116 seals the fuel. A fluid force (referred to as F3), which is proportional to a product of the difference between the fuel pressure inside the fuel injection valve and external pressure leading to a through hole 10, and a seat area, acts in a direction to press the valve body 114B to the valve seat 39 (valve-close direction, downward in FIG. 4). The upper end surface of the anchor 102 and the lower end surface of the head portion 114C of the plunger rod 114A are engaged with each other without any gap. Therefore, the downward fluid force F3 is transmitted to the anchor 102. Accordingly, to cause the anchor 102 to start moving in the direction of the fixed core, it is required, as illustrated in FIG. 3b, that the attraction F1 of the electromagnetic coil exceeds the sum of the spring biasing force F2 and the fluid force F3. Consequently in a conventional fuel injection valve, the anchor 102 starts moving at time T2, which is later than the time T1 for the fuel injection valve using the configuration of the present embodiment, as illustrated in FIG. 3c.

In this manner, the fuel injection valve according to the present embodiment has a preliminary stroke starting timing T1 that does not depend on the fuel pressure inside the fuel injection valve. As illustrated in FIG. 3c, the anchor 102 and the plunger rod 114A move in cooperation with each other and start the regular stroke at the time T3. Magnetic attraction is applied to the plunger rod 114A at the time T3, and momentum of the anchor during the preliminary stroke is applied to the head portion 114C as an impact force. In the conventional fuel injection valve, the attraction F1 of the electromagnetic coil exceeds the sum of the biasing force F2 and the fluid force F3 at time T2, at which the anchor 102 and the plunger rod 114A start the regular stroke. Accordingly, the initial speed of the regular stroke by the anchor 102 and the plunger rod 114A in the present embodiment is greater than in the conventional case. Accordingly, as illustrated in FIG. 3c, the finishing time of the regular stroke in the fuel injection valve of the present embodiment is the time T4, which is earlier than the time T5 for the conventional fuel injection valve.

In this manner, the fuel injection valve according to the present embodiment can decrease the variation in preliminary stroke operation-start timing due to a change in fuel pressure, and quickly perform valve-open operation for the valve body 114B using the regular stroke.

An exemplary method for producing, at the time of producing the fuel injection valve, the gaps G1, G2, and G3 between each of the components illustrated in the enlarged partial view in FIG. 2a, will be described below. The gap G1 between the lower end surface of the head portion 114C of the plunger rod 114A and the upper end surface of the anchor 102 is prescribed by a depth of a recess on the second valve body 152 and a thickness of the head portion 114C of the plunger rod 114A. Note that the gap G1 is equal to the amount of preliminary stroke.

The gap G3 between the lower end surface of the fixed core 107 and the upper end surface of the anchor 102 is prescribed by the amount of movement when the orifice cup 116 is press-fitted into the small-diameter cylindrical portion 22 of the nozzle holder 101 before the stroke stopper 153 is inserted into the fixed core 107. Specifically, applying an electric current to the electromagnetic coil 105 generates magnetic attraction and causes the lower end surface of the fixed core 107 and the upper end surface of the anchor 102 to collide with each other. The second valve body 152 also moves in cooperation with the anchor 102. Therefore, the amount of movement of the second valve body 152 is measured from a fixed core through hole 107D and fed back to the amount of movement of the orifice cup 116, making it possible to prescribe the desirable gap G3.

At the gap G2 between the lower end surface of the stroke stopper 153 press-fitted into the inner diameter portion of the fixed core 107 and the upper end surface of the second valve body 152, magnetic attraction is generated by applying electric current to the electromagnetic coil 105 at the time of insertion of stroke stopper 153 into the fixed core 107. This causes the lower end surface of the stroke stopper 153 to collide with the upper end surface of the second valve body 152. The amount of movement of the second valve body 152 is measured from the fixed core through hole 107D and fed back to the amount of movement of the stroke stopper 153. This makes it possible to prescribe the desirable gap G2. Note that the gap G2 is equal to the regular stroke amount.

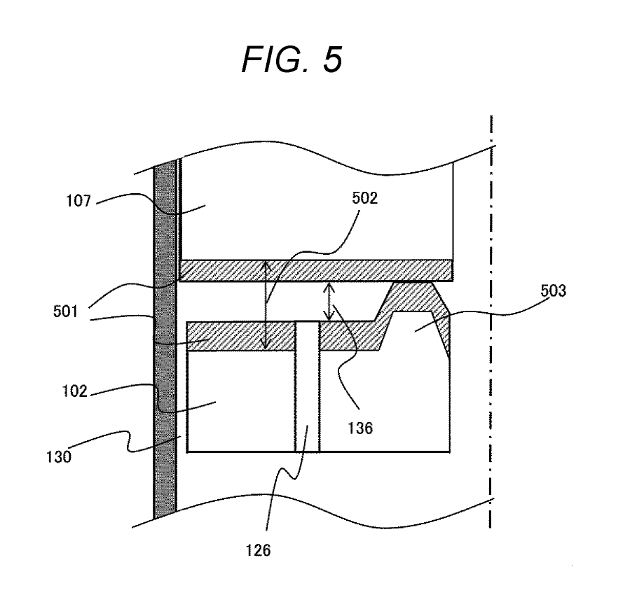

FIG. 5 is an enlarged diagram of the fixed core 107 and the anchor 102 in the conventional fuel injection valve. FIG. 5 illustrates the state in which the electromagnetic coil 105 is energized, and the upper end surface of the anchor 102 and the lower end surface of the fixed core 107 are in contact with each other. In a conventional fuel injection valve, the lower end surface of the core 107 and the upper end surface of the anchor 102 are plated with plating 501 to improve endurance in a collision portion. This has enabled obtaining endurance reliability in the collision portion of the fixed core 107 and the anchor 102 by using hard chrome plating or the like even when soft-magnetic stainless steel, which is relatively soft, is used as the anchor 102 and the fixed core 107.

To obtain endurance reliability in the collision portion, however, the plating 501 to be attached to the fixed core 107 and the anchor 102 is required to have a certain level of thickness or more. Since the plating uses a non-magnetic material, the magnetic gap between the two components is 502 that is a sum of a fluid gap 136 and a thickness of the plating even when the fixed core 107 and the anchor 102 are in contact with each other. In this case, magnetic attraction acting between the two components is lower than a case where the plating 502 is not attached.

On the other hand, the fuel injection valve is required to be able to quickly respond to an input valve-open signal and to open/close the valve. That is, in view of decreasing minimum controllable injection amount (minimum injection amount), it is important to reduce delay time taken for the period from the starting of the valve-open pulse signal to the valve-open state (valve-open delay time), and delay time taken for the period from ending of the valve-open pulse signal to the valve-close state (valve-close delay time). It is known, in particular, that reducing the valve-close delay time is effective in decreasing the minimum injection amount. One technique to reduce valve-close delay time is to increase the load setting for the spring 110, which gives the movable member 114 a force to change the state of the valve body 114B from open to close. If this force is increased, however, greater magnetic attraction F1 would be required at valve-open, leading to a need for a larger electromagnetic coil, which would be a contradictory problem. Due to these design limits, it is difficult to sufficiently reduce valve-open delay time by this technique alone.

There are various types of conventional measures for decreasing the valve-close delay. One of effective measures among these is a technique to provide a protrusion 503 on the anchor 102 to form the fluid gap 136 even in a state where the fixed core 107 and the anchor 102 are in contact with each other. At the time of valve-close, the anchor 102 that has been sucked by an electromagnetic attraction of the fixed core 107 is pressed down by the spring 110. At this time, the fluid gap 136 between the lower end surface of the fixed core 107 and the upper end surface of the anchor 102 is under a negative pressure condition. Using this condition, the fuel pushed away by the shift of the anchor 102 is guided to flow promptly from the fuel passage 118 to the fluid gap 136 and the gap (side gap) 130 on the anchor side. This technique thus decreases a sticking force (squeeze force) generated by a squeeze effect occurring between the lower end surface of the fixed core 107 and the upper end surface of the anchor 102, and reduces the valve-close delay.

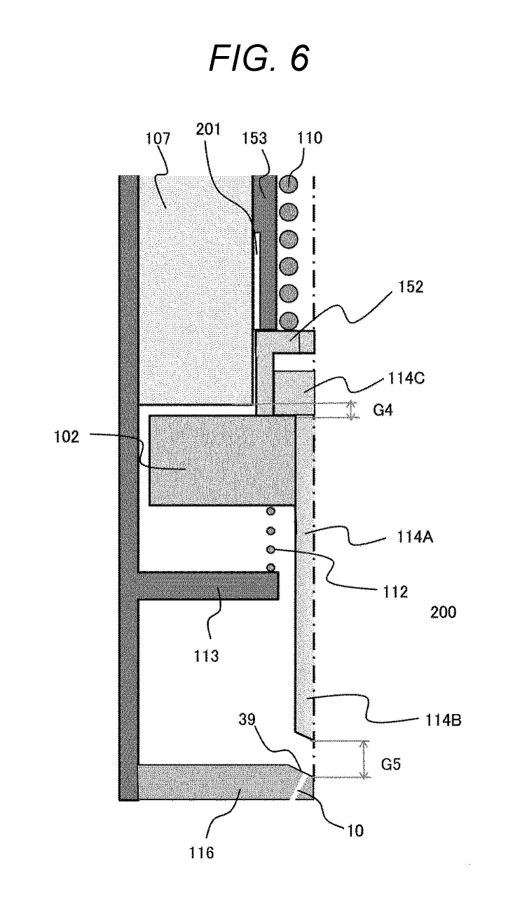

FIG. 6 is an enlarged schematic diagram of a valve-open state of the fuel injection valve according to the present embodiment. The upper end surface of the second valve body 152 is inserted into the inner diameter portion of the fixed core 107, then comes in contact with the lower end surface of the stroke stopper 153. The position of this contact is prescribed. The anchor 112 is attracted toward the fixed core 102 by magnetic attraction, but is regulated to be at a position spaced with a gap G4 by the second valve body 152. The fuel passes through the valve body 114B of the plunger rod 114A and through the valve seat 39 of the orifice cup 116, and then, flows from the injection port 10 into the combustion chamber of the internal combustion engine. Therefore, the fluid force is applied to the plunger rod 114A in a valve-close direction (downward in FIG. 6). Accordingly, the position of the plunger rod 114A is regulated by the condition in which the upper end surface of the anchor 112 supports the head portion 114C.

In this configuration, the fixed core 107 and the anchor 112 have no occasion to directly collide with each other even when the fuel injection valve is in the valve-open state. Therefore, the configuration has an advantage that there is no need to use plating even when soft magnetic stainless steel, which is relatively soft, is used.

In the conventional fuel injection valve illustrated in FIG. 5, the plating 501 is formed with a non-magnetic material, and thus, the magnetic gap 502 is larger than the fluid gap 136 by the thickness of the plating 501. In this, if the fluid gap 136 is increased to reduce the squeeze force, the magnetic gap 502 is also increased. This has led to a problem of decreased magnetic attraction and decline in valve body responsiveness at the time of valve-open.

Without using plating, the magnetic gap and the fluid gap are the same gap G4, as illustrated as a fuel injection valve of the present embodiment in FIG. 6. Accordingly, it is possible to achieve a greater fluid gap with a decreased magnetic gap, compared with the conventional configuration. The stroke stopper has a low-rigidity portion 201 to be a non-press-fitted portion against the fixed core 107 and to alleviate the impact force when the second valve body collides with the stroke stopper. This structure can overcome the impact force at the collision of the second valve body and retain the gap by merely press-fitting the stroke stopper 153 into the fixed core 107. Accordingly, the problem of deterioration of regular stroke amount accuracy due to deformation by welding can be solved. Furthermore, the impact force is alleviated in the low-rigidity portion, making it possible to omit treatment including plating on collision portions on the stroke stopper 153 and the second valve body 152.

FIG. 8 illustrates a relationship of the gap between the fixed core 107 and the anchor 112, with the squeeze force. If the gap is increased from A to B, for example, it is possible to decrease the squeeze force by about 50%. FIG. 3c illustrates changes in the movement of the anchor 102 caused by the decreased squeeze force. The electric current is interrupted at time 0.6 ms, as illustrated in FIG. 3a. The magnetic attraction F1 declines as illustrated in FIG. 3b. When the F1 becomes smaller than the sum of the biasing force F2 of the spring 110 and the fluid force F3 at time T6, the anchor 102 starts closing the valve toward the shoulder portion 113 of the nozzle holder. Since squeeze force is decreased in the fuel injection valve according to the present embodiment. Accordingly, the plunger rod 114A returns to the valve-close position contacting the valve seat 39 at time T7. This timing is earlier than the valve-close time T8 for the conventional fuel injection valve. Accordingly, it is possible to decrease the squeeze force at the time of valve-close and improve valve-close responsiveness, without lowering the magnetic attraction, or with improved magnetic attraction.

In the conventional inventions that are known, it has been not possible to achieve the preliminary stroke at the valve-open and discontinuation of plating with a simple configuration. The present embodiment proposes a configuration of the fuel injection valve that makes it possible to achieve the preliminary stroke at the valve-open and discontinuation of plating without using complicated component configuration. For this, the movable members are divided into three components, that is, the anchor, the first valve body, and the second valve body, and the position of the movable member is determined by the stroke stopper separately arranged from the fixed core.

In this manner, the present embodiment has decreased the valve body response delay at the time of valve-open due to an acting force of the fluid inside the fuel injection valve, while decreasing the sticking force due to squeeze effect at the time of valve-close. Accordingly, it is possible to reduce delay time in open/close valve, and reduce the minimum controllable injection amount (the minimum injection amount), compared with techniques in the conventional art.

The present embodiment is not limited to the above-described embodiment. The components of the present embodiment are not limited to those included in the present configuration, as long as specific functions are not impaired.

For example, the present embodiment has not specifically described the fuel to be used for the fuel injection valve, although it is possible to apply the embodiment to almost all kinds of fuels used in an internal combustion engine, including gasoline, gas oil, and alcohol. The reason is that the present embodiment is implemented in view of viscous resistance of fluids. Since viscous resistance is present in any fuel, the principle of the present embodiment is applicable and effective for any fuel.

### REFERENCE SIGNS LIST

22 nozzle holder small-diameter cylindrical portion
23 nozzle holder large-diameter cylindrical portion
39 valve seat
43A connector
101 nozzle holder
102 anchor
103 housing
104 coil bobbin
105 electromagnetic coil
107 fixed core
107D fixed core through hole (fuel passage)
109 conductor
110 spring
112 zero spring
113 shoulder portion
114 movable member
114A plunger rod
114B valve body
114C plunger rod head portion
115 guide member
116 orifice cup
118 fuel passage
121 resin molded body
126 fuel passage
128 through hole
130 side gap (fuel passage)
150 second core
151 recess
152 second valve body
201 non-press-fitting portion
250 chamfered portions
300 anchor displacement of fuel injection valve according to the present embodiment
301 anchor displacement of conventional fuel injection valve
501 plating
502 magnetic gap
503 protrusion

1.-4. (canceled)

5. A fuel injection valve comprising:
a fixed core;
a solenoid disposed on an outer periphery side of the fixed core;
an anchor configured to face a lower end portion of the fixed core; and
a valve body engaged with the anchor,
the solenoid being energized to generate magnetic attraction, and the anchor and the valve body being attracted to the fixed core to open the valve,
wherein, the valve body includes:
a first valve body that abuts against the anchor at a time of valve-open and that is configured such that a predetermined gap is provided in an axial direction between the first valve body and the anchor at a time of valve-close, and
a second valve body that abuts against the first valve body at a time of valve-close and that is configured to abut against the anchor such that a predetermined gap is provided in an axial direction between the anchor and the fixed core at the time of valve-open.

6. The fuel injection valve according to claim 5,
wherein the second valve body has a recess,
the first valve body abuts against a bottom surface inside the recess at the time of valve-open, and
a predetermined gap is provided in an axial direction, between the first valve body and the bottom surface at the time of valve-close.

7. The fuel injection valve according to claim 5, further comprising a stroke stopper disposed at an inner periphery of the fixed core,
wherein an end of the second valve body in an axial direction abuts against the stroke stopper and another end of the second valve body in the axial direction abuts against the anchor, at the time of valve-open.

8. The fuel injection valve according to claim 5, wherein an upper surface of the anchor and a lower surface of the fixed core are not treated with surface hardening including plating.
